(19) United States
(12) Patent Application Publication
(10) Pub. No.: US 2013/0008966 A1
(43) Pub. Date: Jan. 10, 2013

(54) INTELLIGENT TRAY AND METHOD OF MAKING THE SAME

(75) Inventors: Ming Wa TAM, Hong Kong (HK); Huimin Wang, Hong Kong (HK); Yee Ping Chan, Hong Kong (HK); Xiaoping Zhang, Dongguan (CN); Zhiguang Jiang, Dongguan (CN)

(73) Assignees: Dong Guan Ubot Industrial Co., Ltd.; Ubot Incorporated Limited

(21) Appl. No.: 13/402,832

(22) Filed: Feb. 22, 2012

(30) Foreign Application Priority Data
Jul. 7, 2011 (CN) 201120250133.6

(51) Int. Cl. G06K 19/077; B32B 37/16

(52) U.S. Cl. 235/492; 156/73.1; 156/293

(57) ABSTRACT

An intelligent tray for chips includes a main body having a readable and writable memory unit thereon. The readable and writable memory unit has parameters related to the intelligent tray written therein. The parameters written in the readable and writable memory unit can be read out automatically by a machine, and no need to be manually checked one by one. This helps to automate production, improve production efficiency and shorten production cycle.

### TECHNICAL FIELD

The present invention relates to semiconductor and microelectronics technologies, and also relates to storage devices for chip, and more particularly to an intelligent tray mainly for placement, storage and transportation of packaged chips and silicon wafers.

### DESCRIPTION OF BACKGROUND

Currently, the trays in market are still manufactured simply by injection molding. Some parameters related to the trays are loaded onto the trays by means of injection molding, and can only be manually identified. Therefore, in mass production, there are at least following shortcomings which largely affect the efficiency of production.

Firstly, the parameters related to the trays can only be found from design drawings, and needed to be input into a production machine by customers. The parameters related to the trays include, for example, JEDEC (Joint Electron Device Engineering Council) machine parameters, total height of the trays superimposed together, thickness of the trays, amount of pocket array on the trays, and distance of pocket array on the trays etc. This adversely affects the efficiency of production to some extent.

Secondly, it can only be manually judged whether the trays have any additional functions, such as interlock, anti-compression, anti-reverse etc.

The third shortcoming is: it can only be manually judged whether the manufacturing dates of the trays are in line with the order requirements.

The fourth shortcoming is: it can only be manually known from the marked positions of the trays what types of the items such as chips can be accepted by the trays.

The fifth shortcoming is: the work temperature and vendor code of the trays can only be manually known.

The sixth shortcoming is: it can only be manually judged whether the trays are in line with the order requirements, such as the manufacturing dates, the work temperatures etc.

The seventh shortcoming is: for recycled trays, it would take a lot of time to acquire the information from the trays, about the manufacturing dates, the types of the chips which the trays are applicable, and work temperatures of the trays etc.

The eighth shortcoming is: since all of the parameters are needed to be manually inspected, efficiency of inspection and production is decreased.

### SUMMARY OF THE INVENTION

Therefore, the present invention is to provide an intelligent tray, wherein parameters related to the intelligent tray can be known by detection of a related machine, and no longer by manual check one by one, which helps to automate the production and improve production efficiency and shorten production cycle.

An intelligent tray comprises a main body. The main body has a readable and writable memory unit thereon, and parameters related to the intelligent tray are written in the readable and writable memory unit.

A method of making an intelligent tray is also provided. The method comprises steps of: defining a sink slot in an optional location of a main body of the intelligent tray; placing a readable and writable memory unit into the sink slot, wherein the readable and writable memory unit is written with parameters related to the intelligent tray; positioning the readable and writable memory unit into the sink slot by an adhesive tape or curing adhesive, or enclosing the readable and writable memory unit into the sink slot by a cover.

Furthermore, an engaging groove is defined beside the sink slot, and the cover is inserted into the engaging groove to enclose the readable and writable memory unit into the sink slot.

Furthermore, the cover is welded to the main body to enclose the readable and writable memory unit into the sink slot.

Furthermore, the cover is positioned into the sink slot by ultrasonic plastic welding.

Another method of making an intelligent tray comprises step of embedding a readable and writable memory unit into a main body of the intelligent tray by injection molding or ultrasonic plastic welding, wherein the readable and writable memory unit is written with parameters related to the intelligent tray.

The intelligent tray provided in the embodiments of the present invention helps to automate the production, improve production efficiency and shorten production cycle, and takes an important step to intelligent, fully automated production. The intelligent tray has at least the following advantages:

1. Automatic detection can be realized for the producing enterprises. Specially, all kinds of parameters related the intelligent tray, such as shipment numbers, vendor codes, manufacturing date, and molding number, can be written into the readable and writable memory unit, and customers can know the parameters by a detecting machine.

2. Intelligent and automatic production is further strengthened. Specially, the parameters, such as, JEDEC data, amount and distance of pocket array are written into the readable and writable memory unit, and can be read out automatically and directly applied, no need to be manually set.

3. The warehouse management can be greatly simplified. Specially, the readable and writable memory unit records all parameters related to the trays, this helps automatic warehouse management and quick distribution and recovery.

4. Detection efficiency and productivity can be greatly enhanced. Specially, the information related to the intelligent tray can read out by a computer or a machine, which can be intelligent production and reduce extra working station.

5. The recovery times of the intelligent tray can be automatically counted. The existing method to check the recovery times of the tray can only determined manually. In this invention, the readable and writable memory unit can include an independent internal storage cell to store a recovery code corresponding to the recovery times of the intelligent tray. The recovery code is automatically increased after the readable and writable memory unit is written every time. This recovery code can not be manually modified.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a planar diagram of an intelligent tray.

FIG. 2 is a sectional diagram of a part of an intelligent tray where a readable and writable memory unit is provided, in accordance with a first embodiment of the present invention.

FIG. 3 is a sectional diagram of a part of an intelligent tray where a readable and writable memory unit is provided, in accordance with a second embodiment of the present invention.

FIG. 4 is a sectional diagram of a part of an intelligent tray where a readable and writable memory unit is provided, in accordance with a third embodiment of the present invention.

FIG. 5 is an exploded isometric diagram of a part of an intelligent tray where a readable and writable memory unit is provided, in accordance with a fourth embodiment of the present invention.

FIG. 6 is a sectional diagram of FIG. 5.

FIG. 7 is a sectional diagram of a part of an intelligent tray where a readable and writable memory unit is provided, in accordance with a fifth embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

Taking into account the shortcomings of the existing trays, a new tray with intelligent identification function is provided in the present invention. The tray of the present invention is provided with a readable and writable memory unit on its main body, and has at least following advantages:

Firstly, parameters related to the tray, such as the type of the tray, the date of manufacture, the mold number of the tray can be written into the readable and writable memory unit, and the JEDEC data related to the tray, such as, the pocket array distance and amount, and so on, can also be written into the readable and writable memory unit.

Secondly, the readable and writable memory unit is capable of being embedded in the tray. Therefore, all of the parameters related to the tray can be known by detection of a related machine, and no longer by manual check one by one. This not only helps to realize automated production, but also can improve production efficiency and shorten production cycle.

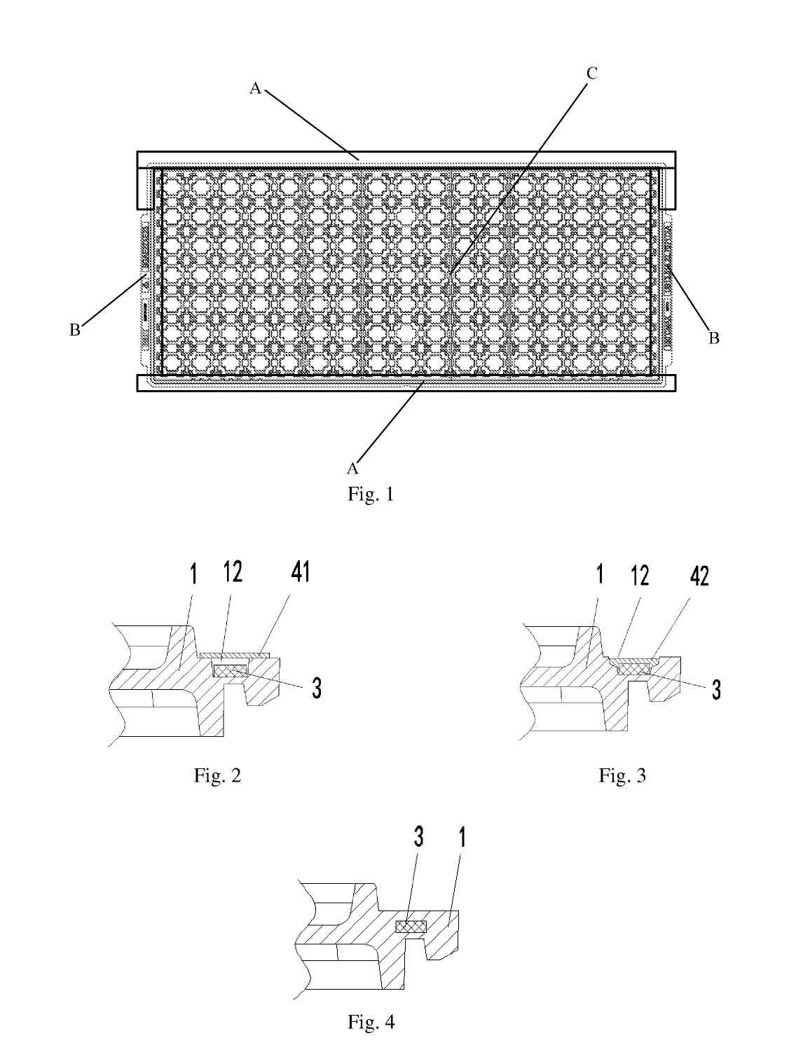

As shown in FIG. 1, the main body of the tray has a frame zone A, a LOGO zone B, and a receiving zone C. The frame zone A and the LOGO zone B are located at an edge of the main body of the tray, and the receiving zone C is surrounded by the frame zone A and the LOGO zone B. A plurality of pockets (not labeled) is provided in the receiving zone C, for receiving IC and other items. The pockets are arranged in a matrix. Specially, a sink slot for installing the readable and writable memory unit is provided in the main body of the tray. The sink slot is located at one of the frame zone A, the LOGO zone B, and the receiving zone C.

The parameters related to the tray are written into the readable and writable memory unit in advance. The readable and writable memory unit is implemented, for example, by an identifying IC (Integrated Chip). Specially, a small high-frequency coil (not shown) is embedded in the identifying IC, and the high-frequency coil is sensitive to signals outputted from a corresponding external high-frequency coil and intercommunicates with the external high-frequency coil, so that the identifying IC can be interacted with an external readable and writable device. Specially, the external readable and writable device sends high-frequency signals by means of high-frequency coil in its external antenna, to the identifying IC. The high-frequency coil embedded in the identifying IC senses the high-frequency signal from the external antenna, and accordingly responds to the high-frequency signal from the external antenna, for example, to write the high-frequency signal into the identifying IC or output data from the identifying IC to the external readable and writable device.

The readable and writable memory unit can be enclosed in the sink slot of the main body of the tray by an adhesive tape, or glue, or curing adhesive, or be embedded in the main body of the tray by injection molding or ultrasonic plastic welding. In other embodiments, the readable and writable memory unit can also be enclosed in the sink slot by a cover, wherein the cover can be buckled to the main body or positioned to the main body by ultrasonic plastic welding. More detailed description of installation the readable and writable memory unit to the tray is illustrated hereafter.

### The First Embodiment

As shown in FIG. 2, the sink slot 12 is defined in an optional location of the main body 1 of the tray. The readable and writable memory unit 3 provided with parameters related to the tray is placed into the sink slot 12. An adhesive tape 41 is put onto the tray by a machine, so that the readable and writable memory unit 3 is positioned in the sink slot 12, and prevented from falling out of the sink slot 12.

### The Second Embodiment

As shown in FIG. 3, the sink slot 12 is defined in an optional location of the main body 1 of the tray. The readable and writable memory unit 3 provided with parameters related to the tray is placed into the sink slot 12. Glue or curing adhesive is dropped into the sink slot 12. After the glue or curing adhesive is cured, the readable and writable memory unit 3 is positioned in the sink slot 12, and prevented from falling out of the sink slot 12.

### The Third Embodiment

As shown in FIG. 4, the readable and writable memory unit is embedded in an optional location of the main body 1 of the tray, by injection molding or ultrasonic plastic welding, to prevent the readable and writable memory unit 3 from falling out of the tray.

### The Fourth Embodiment

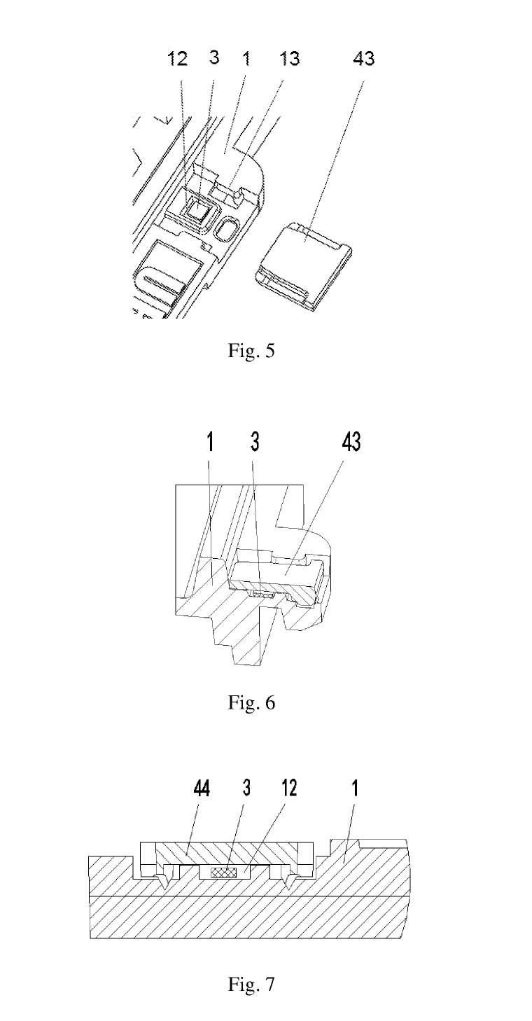

As shown in FIG. 5 and FIG. 6, the sink slot 12 is defined in an optional location of the main body 1 of the tray. An engaging groove 13 is defined in the tray beside the sink slot 12. The readable and writable memory unit 3 is placed into the sink slot 12. A cover 43, such as a plastic cover, is inserted into the engaging groove 13, to enclose the readable and writable memory unit 3 into the sink slot 12 and prevent the readable and writable memory unit 3 from falling out of the sink slot 12. Alternatively, the cover 43 can also be positioned into the sink slot 12 by welding.

### The Fifth Embodiment

As shown in FIG. 7, the sink slot 12 is defined in an optional location of the main body 1 of the tray. The readable and writable memory unit 3 is placed into the sink slot 12. The sink slot 12 is covered by a cover 44, such as a plastic cover. The cover 44 is positioned in the sink slot 12 by ultrasonic plastic welding to prevent the readable and writable memory unit 3 from falling out of the sink slot 12.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An intelligent tray comprising a main body, the main body having a readable and writable memory unit thereon, the readable and writable memory unit having parameters related to the intelligent tray written therein.

2. The intelligent tray as described in claim 1, wherein the main body has a sink slot defined therein, and the readable and writable memory unit is enclosed in the sink slot.

3. The intelligent tray as described in claim 2, wherein the sink slot is located at an optional location of the main body.

4. The intelligent tray as described in claim 3, wherein the main body has a frame zone and a LOGO zone located at an edge of the main body, and the sink slot is located at the LOGO zone.

5. The intelligent tray as described in claim 3, wherein the readable and writable memory unit is enclosed in the sink slot by an adhesive tape.

6. The intelligent tray as described in claim 3, wherein the readable and writable memory unit is enclosed in the sink slot by glue or curing adhesive.

7. The intelligent tray as described in claim 1, wherein the readable and writable memory unit is embedded in the main body.

8. The intelligent tray as described in claim 3, wherein the readable and writable memory unit is enclosed into the sink slot by a cover.

9. The intelligent tray as described in claim 8, wherein the cover is buckled to the main body to enclose the readable and writable memory unit in the sink slot.

10. The intelligent tray as described in claim 8, wherein the cover is welded to the main body to enclose the readable and writable memory unit in the sink slot.

11. A method of making an intelligent tray, comprising steps of:
defining a sink slot in an optional location of a main body of the intelligent tray;
placing a readable and writable memory unit into the sink slot, wherein the readable and writable memory unit is written with parameters related to the intelligent tray;
positioning the readable and writable memory unit into the sink slot by an adhesive tape or curing adhesive, or enclosing the readable and writable memory unit into the sink slot by a cover.

12. The method as described in claim 11, wherein an engaging groove is defined beside the sink slot, and wherein the cover is inserted into the engaging groove to enclose the readable and writable memory unit into the sink slot.

13. The method as described in claim 11, wherein the cover is welded to the main body to enclose the readable and writable memory unit into the sink slot.

14. The method as described in claim 11, wherein the cover is positioned into the sink slot by ultrasonic plastic welding.

15. A method of making an intelligent tray, comprising step of embedding a readable and writable memory unit into a main body of the intelligent tray by injection molding or ultrasonic plastic welding, wherein the readable and writable memory unit is written with parameters related to the intelligent tray.
